(19) United States
(12) Patent Application Publication
(10) Pub. No.: US 2011/0305386 A1
(43) Pub. Date: Dec. 15, 2011

(54) Color Indication Tool for Colorblindness

(75) Inventors: Meng Wang, Beijing (CN); Xian-Sheng Hua, Beijing (CN)

(73) Assignee: Microsoft Corporation, Redmond, WA (US)

(21) Appl. No.: 12/816,026

(22) Filed: Jun. 15, 2010

(51) Int. Cl. G06K 9/34; G06K 9/00

(52) U.S. Cl. 382/164; 382/165

(57) ABSTRACT

A color indication tool is described that enables a colorblind user to better perceive and recognize visual documents. An exemplary process utilizes a user-input device, such as a mouse or a stylus, to identify a pixel, region, object within an image. The color indication tool provides an indication of the color of the identified pixel, region or object.

### BACKGROUND

Colorblindness, formally referred to as color vision deficiency, affects about 8% of men and 0.8% of women globally. Colorblindness causes those affected to have a difficult time discriminating certain color combinations and color differences. Colors are perceived by viewers through the absorption of photons followed by a signal sent to the brain indicating the color being viewed. Generally, colorblind viewers are deficient in the necessary physical components enabling them to distinguish and detect particular colors. As a result of the loss of color information, many visual objects, such as images and videos, which have high color quality in the eyes of a non-affected viewer, cannot typically be fully appreciated by those with colorblindness.

For example, colorblindness is typically caused by the deficiency or lack of a certain type of cone in the user's eye. Cones may be categorized into Long (L), Middle (M), and Short (S), corresponding to the wavelength that they are capable of absorbing. If the viewer is deficient in an L-cone, an M-cone, or an S-cone, they are generally referred to as protanopes, deuteranopes, and tritanopes, respectively. Protanopes and deuteranopes have difficulty discriminating red from green, whereas tritanopes have difficulty discriminating blue from yellow. No matter the specific type of color deficiency, a colorblind viewer may have difficulty when searching for an image that contains a specific color, for example, a red apple. Unfortunately, the colorblind viewer may not be able to distinguish whether an apple in an image is red or green.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In view of the above, this disclosure describes an exemplary method, system, and computer-readable media for implementing a tool and process to enhance a colorblind user's experience by indicating colors in an image based on a pixel, a region, or an object.

In an exemplary implementation, an image is transformed to a more desirable color space. For example the image may be transformed from a color space such as a red, green, blue (RGB) color space to a more usable color space such as a CIE L*a*b* (CIELAB) color space. At least two color values within the image are then be selected within the CIELAB color space. A color difference between the two color values is calculated and utilized to construct a hash table for use of identification of colors following a color extraction of a designated portion of the image. A description of the identified color is presented.

A color identification tool is used to identify colors of an image at a pixel level, a region level, or an object level. For example, an image may be selected by a colorblind user. The colorblind user may use the color identification tool to designate an area within the image. Calculating color differences within the designated area of the image, a description (e.g., a name) of the color is displayed to the colorblind user.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical items.

FIG. 1 is a schematic of an illustrative architecture of a color indication framework.

FIG. 2 is a block diagram of an exemplary computing device within the color indication framework of FIG. 1.

FIG. 3 is a diagram of an exemplary color space transformation within the color indication framework of FIG. 1.

FIG. 4 is an illustrative scheme of the color indication framework of FIG. 1

FIG. 5A and FIG. 5B are illustrations of exemplary region-level indications within the color indication framework of FIG. 1.

FIG. 6A and FIG. 6B are illustrations of exemplary object-level indications within the color indication framework of FIG. 1.

FIG. 7 is a flow chart of an exemplary use of a color indication tool for indicating a color within an image.

### DETAILED DESCRIPTION

A color indication tool and process to enhance a colorblind user's experience by indicating colors in an image based on a pixel, a region, or an object are described. More specifically, an exemplary process identifies a pixel, region, or object based on input from a pointer-type device (e.g., a mouse or a stylus). For example, when a mouse-controlled cursor is hovered over or placed on an image, the color of the pixel, region or object that the tool is hovering over or placed on is indicated (e.g., by a textual description). The color indication tool enables a colorblind user to better perceive and recognize visual documents as well as communicate with non colorblind viewers.

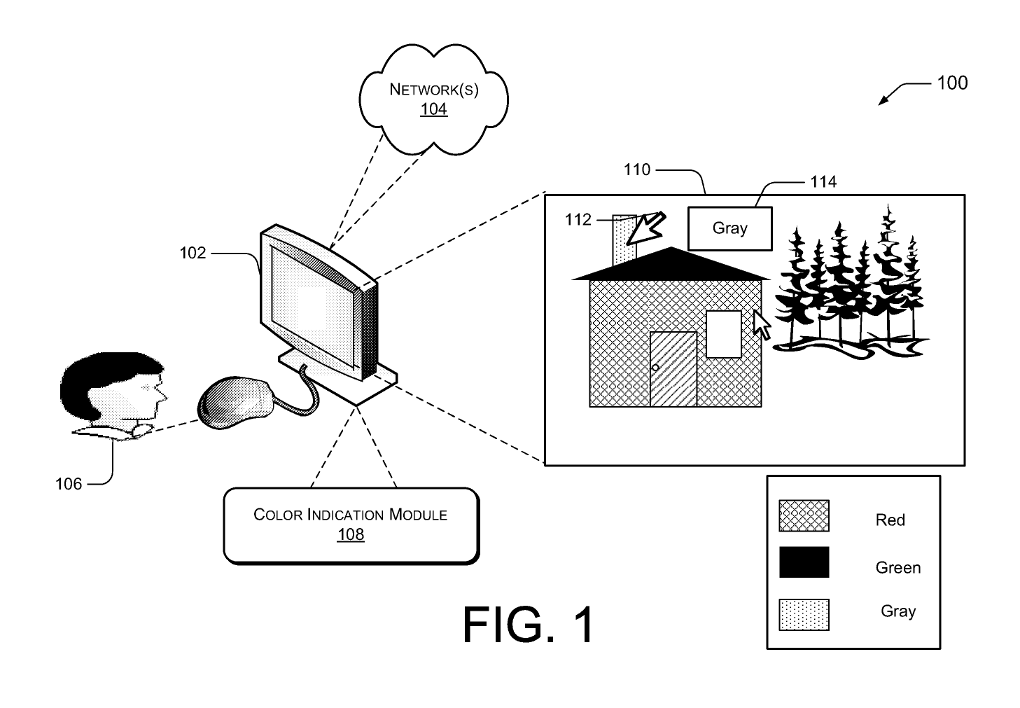

FIG. 1 is a block diagram of an exemplary environment 100, which is used for the indication of a color within an image on a computing device. The environment 100 includes an exemplary computing device 102, which may take a variety of forms including, but not limited to, a portable handheld computing device (e.g., a personal digital assistant, a smart phone, a cellular phone), a laptop computer, a desktop computer, a media player, a digital camcorder, an audio recorder, a camera, or any other similar device.

The computing device 102 may connect to one or more networks(s) 104 and is associated with a user 106. The computing device 102 may include a color indication module 108 to distinguish one or more colors within an image 110. For example, as illustrated in FIG. 1, a user may identify a portion of the image 110 using a cursor 112. Placing the cursor over the portion of the image, the color indication module 108 presents a non-color representation 114 of a color corresponding to that portion.

The network(s) 104 represent any type of communications network(s), including, but not limited to, wire-based networks (e.g., cable), wireless networks (e.g., cellular, satellite), cellular telecommunications network(s), and IP-based telecommunications network(s) (e.g., Voice over Internet Protocol networks). The network(s) 104 may also include traditional landline or a public switched telephone network (PSTN), or combinations of the foregoing (e.g., Unlicensed Mobile Access or UMA networks, circuit-switched telephone networks or IP-based packet-switch networks).

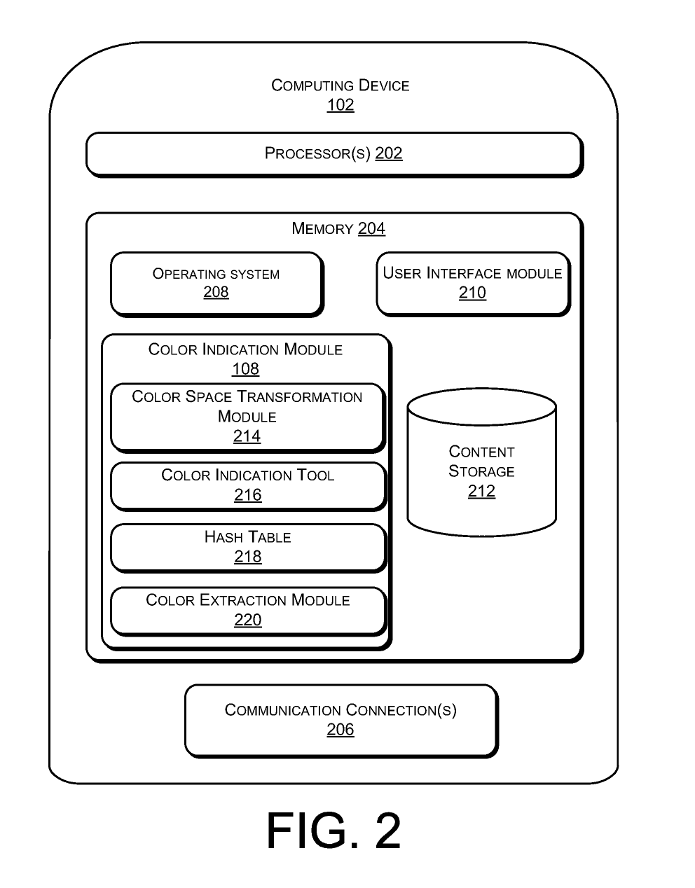

FIG. 2 illustrates an exemplary computing device 102. The computing device 102 includes, without limitation, a processor 202, a memory 204, and one or more communication connection 206. An operating system 208, a user interface (UI) module 210, a color indication module 108, and a content storage 212 are maintained in memory 204 and executed on the processor 202. When executed on the processor 202, the operating system 208 and the UI module 210 collectively facilitate presentation of a user interface on a display of the computing device 102.

The communication connection 206 may include, without limitation, a wide area network (WAN) interface, a local area network interface (e.g., WiFi), a personal area network (e.g., Bluetooth) interface, and/or any other suitable communication interfaces to allow the computing device 102 to communicate over the network(s) 104.

The computing device 102, as described above, may be implemented in various types of systems or networks. For example, the computing device may be a stand-alone system, or may be a part of, without limitation, a client-server system, a peer-to-peer computer network, a distributed network, a local area network, a wide area network, a virtual private network, a storage area network, and the like.

The computing device 102 accesses a color indication module 108 that presents non-color indications of one or more colors within an image 110. Color indication module 108 includes, without limitation, a color space transformation module 214, a color indication tool 216, a hash table 218, and a color extraction module 220. Color indication module 108 may be implemented as an application in the computing device 102. As described above, the color indication module deciphers colors within a visual object to enable a colorblind user to better perceive the visual object. Content storage 212 provides local storage of images for use with the color indication module 108.

The transformation module 214 transforms the colors within image 110 from a first color space to a second color space. The color indication tool 216 identifies a pixel, region, or object within the image based on user input. The user input is received through any of a variety of user input devices, including, but not limited to, a mouse, a stylus, or a microphone. Based on the user input along with information contained in a hash table 218, the color indication tool selects a portion of the image to be analyzed by a color extraction module 220.

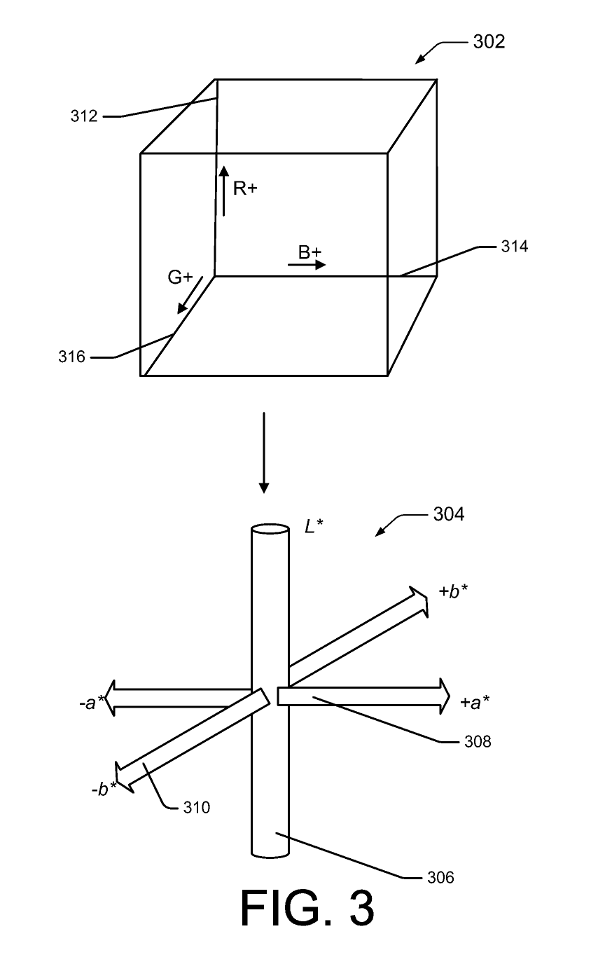

FIG. 3 illustrates an exemplary color space transformation. Example color space transformation module 214 transforms a color within a red, green, blue (RGB) color space 302 or a cyan, magenta, yellow, and black (CMYK) color space (not shown) into a color within a CIE L*a*b* (CIELAB) color domain or space 304. The RGB color space model and the CMYK color space model are both designed to render images on devices having limited color capabilities. In contrast, the CIELAB space is designed to better approximate human vision, and therefore provides more subtle distinctions across a larger number of colors.

Each color within the CIELAB color space 304 is represented by a set of coordinates expressed in terms of an L* axis 306, an a* axis 308, and a b* axis 310. The L* axis 306 represents the luminance of the color. For example, if L*=0 the result is the color black and if L*=100 the result is the color white. The a* axis represents a scale between the color red and the color green, where a negative a* value indicates the color green and a positive a* value indicates the color red. The b* axis represents a scale between the color yellow and the color blue, where a negative b* value indicates the color blue and a positive b* value indicates the color yellow.

The L* axis 306 closely matches human perception of lightness, thus enabling the L* axis to be used to make accurate color balance corrections by modifying output curves in the a* and the b* coordinates, or to adjust the lightness contrast using the L* axis. Furthermore, uniform changes of coordinates in the L*a*b* color space generally correspond to uniform changes in a users 106 perceived color, so the relative perceptual differences between any two colors in the L*a*b* color space may be approximately measured by treating each color as a point in a three dimensional space and calculating the distance between the two points.

In one implementation, the distance between the L*a*b* coordinates of one color and the L*a*b* coordinates of a second color may be determined by calculating the Euclidean distance between the first color and the second color. However, it is to be appreciated that any suitable calculation may be used to determine the distances between the two colors.

While there are no simple conversions between an RBG value or a CMYK value and L*, a*, b* coordinates, methods and processes for conversions are known in the art. For example, in one implementation, the color transformation module 214 uses a process referred to herein as a forward transformation process. It is to be appreciated however that any suitable transformation method or process may be used. As illustrated in FIG. 3, the forward transformation method converts RGB coordinates corresponding to a y-coordinate along the y-axis 312, an x-coordinate along the x-axis 314, and a z-coordinate along the z-axis 316, respectively, to an L* coordinate along the L* axis 306, an a* coordinate along the a* axis 308, and a b* coordinate along the b* axis 310. The forward transformation process is described below. The order in which the operations are described is not intended to be construed as a limitation.

$$\begin{matrix}{L}^{*} = 116 f ( Y / {Y}_{n} ) - 16 & Equation ( 1 ) \\ {a}^{*} = 500 [ f ( X / {X}_{n} ) - f ( Y / {Y}_{n} ) ] & Equation ( 2 ) \\ {b}^{*} = 200 [ f ( Y / {Y}_{n} ) - f ( Z / {Z}_{n} ) ] \\ where & Equation ( 3 ) \\ f ( t ) = \{ \begin{matrix}{t}^{1 / 3} & t > {( 6 / 29 )}^{3} \\ \frac{1}{3} {( \frac{29}{6} )}^{2} t + \frac{4}{29} & otherwise\end{matrix} & Equation ( 4 )\end{matrix}$$

The division of the f(t) function into two domains, as shown above in Equation (4) prevents an infinite slope at t=0. In addition, as set forth in Equation (4), f(t) is presumed to be linear below t=t₀, and to match the t^{1/3} part of the function at t₀ in both value and slope. In other words:

t₀^{1/3}=at₀+b(match in value) Equation (5)

1/3ₜ₀^{2/3}=a(match in slope) Equation (6)

Setting the value of b to be 16/116 and δ=6/29, Equations (5) and (6) may be solved for a and t₀:

a=1/3δ²)=7.7878037 Equation (7)

tₒ=δ³=0.008856 Equation (8)

Color transformation module 214 may also perform a reverse transformation process, transforming values from the CIELAB space 304 to the corresponding RGB values or the CMYK values. In one implementation, the reverse transformation process may include the following steps:

1. Define f_{y}^{def}=(L*+16)/116 Equation (9)

2. Define fₓ^{def}=f_{y}+a*/500 Equation (10)

3. Define f_{≈}^{def}=f_{y}−b*/200 Equation (11)

4. if f_{y}>δ then Y=Yₙf³_{y} else Y=(f_{y}−16/116)3δ²Yₙ Equation (12)

5. if fₓ>δ then X=Xₙf³ₓ else X=(fₓ−16/116)3δ²Xₙ Equation (13)

6. if f_{z}>δ then Z=Zₙf³_{z} else Z=(f_{z}−16/116)3δ²Zₙ Equation (14)

However, the order in which the process is described is not intended to be construed as a limitation. It is to be appreciated that the reverse transformation process may proceed in any suitable order.

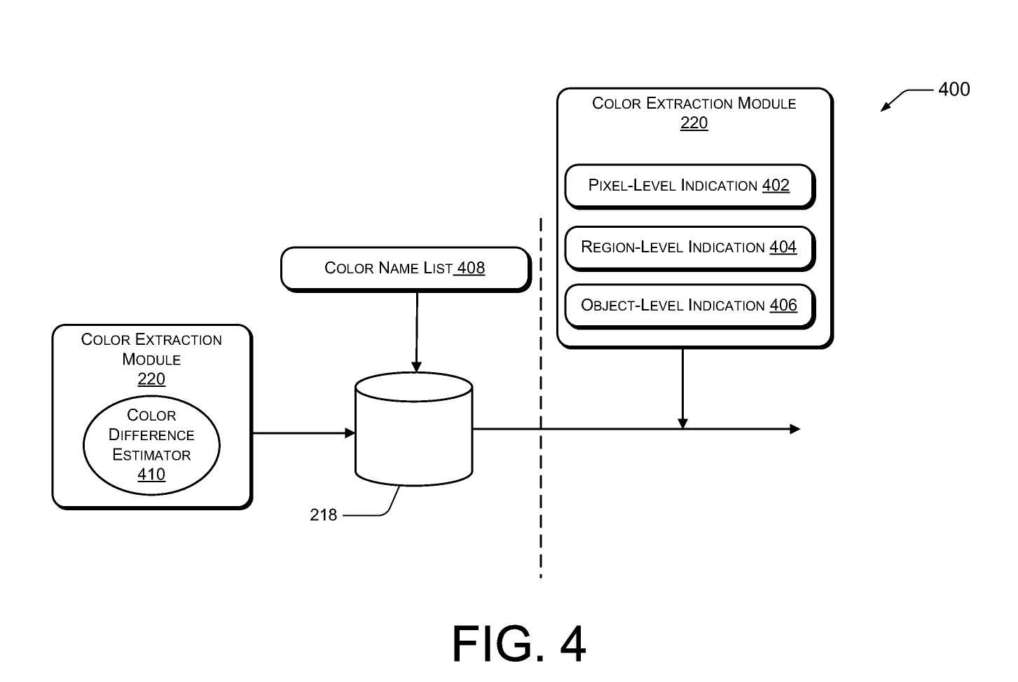

FIG. 4 illustrates an exemplary scheme 400 for use with the color indication module 108. As shown in FIG. 4, example color extraction module 220 may support three color extraction methods, including without limitation, a pixel-level indication 402, a region-level indication 404, and an object-level indication 406. A common component within the three color extraction methods is the hash table 218. The hash table 218 maps a color value in a red, green, blue (RGB) color space to a designated color name, utilizing a color name list 408. The color name list 408 may be similar to that shown below in Table 1. The color name list 408 assigns an RGB combination to a color name. In the described implementation, the color name list 408 is based upon the X11 color names that are standardized by the Scalable Vector Graphics (SVG) 1.0. Indicating too many colors, particularly those colors which are rarely used, may degrade the experience of user 106. Therefore, Table 1 contains names of 38 commonly used colors associated with the corresponding RGB value. In one implementation, the RGB values are all quantized with 256 levels, meaning 256×256×256. It is, however, to be appreciated that any other suitable representation may be used.

TABLE 1

| Color Name | RGB Value |
|---|---|
| Red | 0xFF0000 |
| Fire Brick | 0xB22222 |
| Dark Red | 0x8B0000 |
| Pink | 0xFFC0CB |
| Deep Pink | 0xFF1493 |
| Coral | 0xFF7F50 |
| Tomato | 0xFF6347 |
| Orange Red | 0xFF4500 |
| Orange | 0xFFA500 |
| Gold | 0xFFD700 |
| Yellow | 0xFFFF00 |
| Light Yellow | 0xFFFFE0 |
| Violet | 0xEE82EE |
| Fuchsia | 0xFF00FF |
| Amethyst | 0x9966CC |
| Blue Violet | 0x8A2BE2 |
| Purple | 0x800080 |
| Green Yellow | 0xADFF2F |
| Light Green | 0x90EE90 |
| Green | 0x008000 |
| Yellow Green | 0x9ACD32 |
| Olive | 0x808000 |
| Teal | 0x008080 |
| Cyan | 0x00FFFF |
| Light Cyan | 0xE0FFFF |
| Sky Blue | 0xEOFFFF |
| Blue | 0x0000FF |
| Dark Blue | 0x00008B |
| Wheat | 0xF5DEB3 |
| Tan | 0xD2B48C |
| Chocolate | 0xD2691E |
| Sienna | 0xA0522D |
| Brown | 0xA52A2A |
| Maroon | 0x800000 |
| White | 0xFFFFFF |
| Silver | 0xC0C0C0 |
| Gray | 0x808080 |
| Black | 0x000000 |

In one implementation, the 38 colors contained in Table 1 are manually selected by the user 106. The 38 colors may be selected based upon multiple factors, including without limitation, the coverage of the color, the diversity of the color, or the usage frequency of that color. Alternatively, the colors contained within Table 1 may be automatically selected by the color indication module 108 based upon criteria including, without limitation, maximizing color diversity, or maintaining a color's name usage above a set threshold.

The color indication module 108 maps each color in the RGB color space to a color name listed in Table 1. In one implementation, each color may be mapped using a “nearest neighbor” approach. That is, for each color, a difference between a value of the color and values of those colors in color name list 408 is calculated. The name in the color name list 408 having a value with the smallest difference is selected and designated as the “nearest neighbor” and therefore the designated color name for the particular color.

The difference may be calculated, for example, using a Euclidean distance between the colors within the RGB color space. However, generally it is desirable to calculate the difference in a CIELAB color space rather than the RGB color space, because the RGB color space model is designed to represent images on a physical output device (e.g., a display screen). In contrast, the CIELAB color space is designed to approximate human vision and therefore provides for a more pleasant result to the user 106. Therefore,

Following the transformation into CIELAB color space, as described above with reference to FIG. 3, color difference estimator 410 may calculate the difference between two colors using the obtained CIELAB values for each color. The difference may be defined as:

ΔE={square root over ((L₁*)}−L₂*)²+(a₁*−a₂*)²+(b₁*−b₂*)² Equation (15)

Based upon the color name list 408 and the value calculated using the color difference estimator 410, the hash table 218 is constructed. The hash table 218 enables every RGB value to be mapped to a designated color name within Table 1.

As described above, the color indication module 108 may support three color extraction methods, including without limitation, a pixel-level indication 402, a region-level indication 404, and an object-level indication 406. Based upon the desired level of granularity, the color indication tool 216 identifies a pixel, region, or object based on user input.

Pixel-level indication 402 is generally suitable for images where the user 106 would like to know the color of a very fine target, such as the characters on a web page or a desktop menu. User 106 may use the color identification tool 216 to designate a pixel within the image, for example, by using a mouse to move a cursor around an image displayed on computing device 102. When the user 106 holds the cursor on a pixel for a period of time, for example 0.5 seconds, then color indication tool 216 determines the color of the pixel under the cursor, and color indication module 108 uses the information within hash table 218 to indicate the color of that particular pixel. The color may be displayed in text such as “Red”, or alternatively, a symbol may be displayed whereby the user 106 would refer to a legend indicating what color the symbol represents. Further, the color may be communicated to the user through an audio presentation.

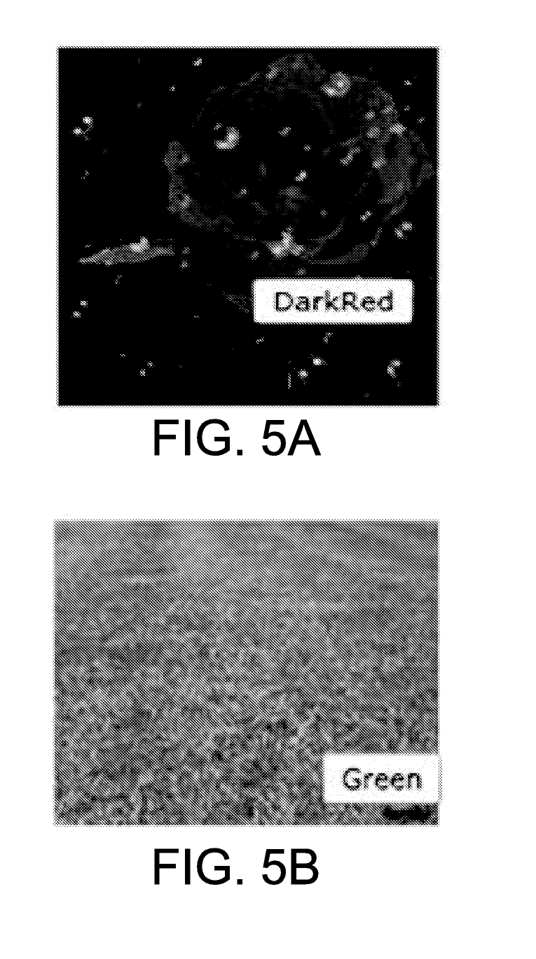

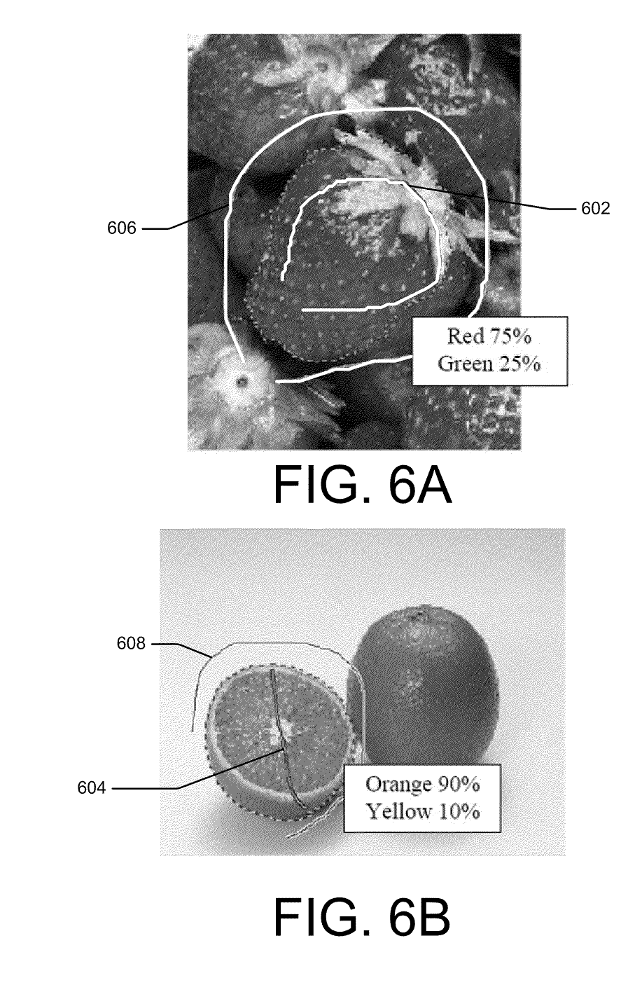

Region-level indication 404 is used to identify a color within an image based on a selected region, larger than a single pixel. Similarly, object-level indication 406 is used to identify a color of a particular object within an image. Region-level indication 404 is described in further detail below, with reference to FIGS. 5A and 5B. Object-level indication 406 is described in further detail below, with reference to FIGS. 6A and 6B.

FIGS. 5A and 5B illustrate an exemplary region-level indication. Region-level indication 404 enables the user to select, using the color indication tool 216, a portion (larger than a pixel) within an image. The color indication tool 216 may, for example, associate a shape or form with the cursor. For example, the shape or form may be selected by the user 106 from a number of available shapes including, without limitation, a square, a rectangle, an oval, a circle, or some suitable shape or form capable of highlighting a region of the image. When the user 106 selects a region (e.g., by dragging a cursor to create shape), the color indication tool 216 identifies the region of the image within the shape. The color indication module 108 then determines the color of the selected region, for example, by computing the mean of the colors within the selected region. For example, if the selected region is in the shape of a square, and has dimensions of 20 pixels×20 pixels, then a mean of the 400 pixels within those dimensions would be calculated. The name of the color is then presented in text such as “DarkRed” or “Green”, or alternatively, a symbol may be displayed whereby the user 106 would refer to a legend indicating what color the symbol represents. Further, the color may be communicated to the user through an audio presentation.

FIGS. 6A and 6B illustrate an exemplary object-level indication. Object-level indication 406 queries the color or colors of an entire object within an image. In one implementation, a lazy snapping technique may be used to identify the object.

In one implementation, the lazy snapping technique provides instant visual feedback to the user by combining a process including, without limitation, a graph cutout with a boundary editing. The image cutout technique removes an object within an image from the background portion of the image. The cutout technique utilizes at least two strategically located lines placed by the user within the image. For example, a first line 602 or 604 may be drawn using the color indication tool 216 on the foreground of the object that the user 106 is interested in. The second line 606 or 608 may be drawn on the background of the image.

Using these two lines, the lazy snapping algorithm establishes the boundary of the foreground object. The boundary editing technique enables the user 106 to edit the object boundary determined by the lazy snapping algorithm. In an example implementation, the user edits the object boundary by selecting and dragging one or more polygon vertices along the boundary of the cutout object.

After establishing the boundary of the object, the color name for each pixel within the object may be determined. The frequency of each color name may be counted and presented if the color count is above a set threshold, for example, 5%. In one implementation, the threshold may be set by the user 106 or by the color indication module 108, or a combination thereof.

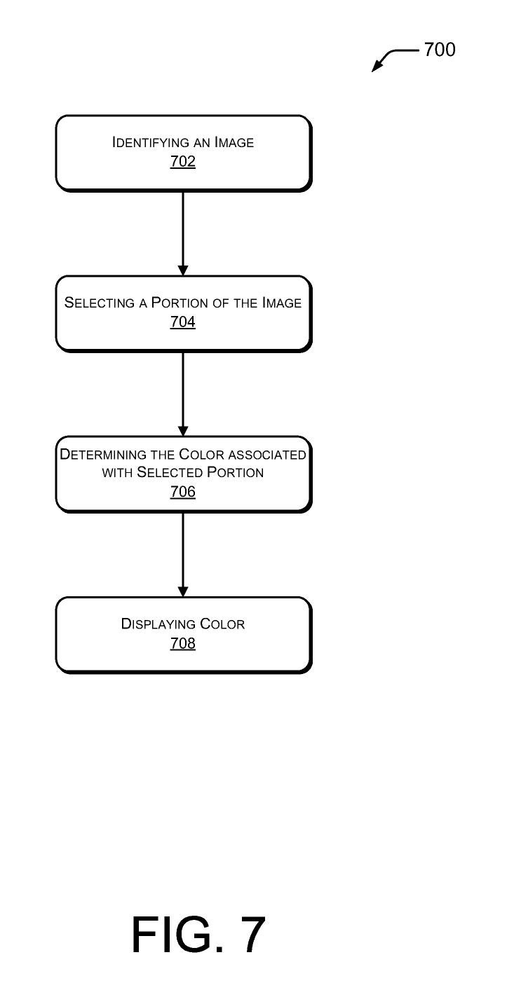

FIG. 7 illustrates an exemplary method 700 outlining the color indication process for an image set forth above. At block 702, an image 110 is identified by the colorblind user 106 or the computing device 102.

At block 704, a color indication tool 216 is used by the colorblind user to select a portion of the image 110. For example, colorblind user 106 may want to know the color(s) of a specific pixel, region, or object within the image. The color indication tool 216 enables the user to select the desired portion of the image.

At block 706, color indication module 108 determines the color(s) associated with the designated portion. For example, selection of a pixel within an image results in the indication of the color of that specific pixel. Selection of a region within the image results in a mean calculation of the designated region. Selection of an object within the image results in a technique, for example a lazy snapping technique, used to determine the frequency of the appearance of color(s) within the designated object.

In an example implementation, the color indication module 108 determines the color(s) associated with the designated portion of the image through the use of a hash table. The hash table may be constructed using a combination of calculated color difference values and an established color name list. For example, a color name list may be created similar to Table 1, above. The second component of the hash table, the color difference values, may be calculated using two colors and the corresponding coordinates within the CIELAB color space.

At block 708, the color of the designated pixel, region, or object is presented using computing device 102. The color may be displayed in text format, for example “Red”, a symbol corresponding to the color may be displayed, or any other suitable method may be used to convey the color of the designated portion of the image.

### CONCLUSION

Although an indication process for identifying the colors of images to make them better perceived by colorblind users has been described in language specific to structural features and/or methods, it is to be understood that the subject of the appended claims are not necessarily limited to the specific features or methods described. Rather, the specific features and methods are disclosed as exemplary implementations.

What is claimed is:

1. A method comprising:
selecting a first set of color values within a desired image;
transforming the first set of color values in a first color space to a second set of color values in a second color space;
estimating a color difference between a first color within the second set of color values and a second color within the second set of color values;
constructing a hash table utilizing the estimated color difference and one or more values corresponding to a color name list;
performing a color extraction on a designated portion of the image;
comparing a result of the color extraction to the hash table to determine a color name associated with the designated portion of the image; and
presenting the color name associated with the designated portion of the image.

2. The computer-implemented method of claim 1, wherein the first color space is a red, green, blue (RGB) color space and the second color space is a CIE L*a*b* (CIELAB) color space.

3. The method of claim 1, wherein the color difference is determined by calculating a difference between coordinates L₁*, a₁*, b₁* of the first color and coordinates L₂*, a₂*, b₂* of the second color.

4. The method of claim 1, wherein the color extraction is a pixel-level extraction, a region-level extraction, or an object-level extraction.

5. The method of claim 1, wherein the designated portion of the image is a single pixel and the color name is a name of a color associated with the single pixel.

6. The method of claim 1, wherein:
the designated portion of the image comprises a plurality of pixels; and
performing the color extraction comprises computing a mean color value for the plurality of pixels.

7. The method of claim 1, wherein:
the designated portion of the image comprises an object represented within the image; and
performing the color extraction comprises:
determining a color of each pixel within the object; and
determining a frequency of each color appearing within the object.

8. A color indication system comprising:
a memory;
one or more processors coupled to the memory;
a color indication module operable on the one or more processors, the color indication module comprising:
a color indication tool utilized to extract one or more colors within an area of an image;
a hash table to determine the one or more colors within the specified area of the image, the hash table comprising:
one or more color difference values, the difference determined by calculating the difference between coordinates L₁*, a₁*, b₁* of a first color and coordinates L₂*, a₂*, b₂* of a second color; and
a color name list constructed with colors selected based upon one or more parameters; and
a display presenting the determined one or more colors of the image.

9. The color indication system of claim 8, wherein the one or more parameters are manually selected by a user and comprise a color coverage, a diversity of colors, or a color usage frequency.

10. The color indication system of claim 8, wherein the one or more parameters are automatically selected by the color indication module.

11. The color indication system of claim 8, wherein the color indication tool received user input through a mouse, a stylus, a voice command, or a user interface device.

12. The color indication system of claim 11, wherein the color indication tool associates a form with the user interface device, enabling a region of the image to be extracted.

13. The color indication system of claim 11, wherein the user indication tool enables an object level extraction comprising:
identifying a first line associated with a foreground portion of the image;
identifying a second line associated with a background portion of the image;
establishing a boundary of an object based on the first line and the second line;
determining one or more colors within the boundary of the object.

14. The color indication system of claim 13 further comprising presenting names of particular ones of the one or more colors, wherein the particular ones of the one or more colors occur with a count frequency greater than or equal to a set threshold.

15. One or more computer-readable media storing computer-executable instructions that, when executed on one or more processors, cause the one or more processors to perform operations comprising:
identifying a portion of an image based on input received through a user interface device;
comparing a value associated with the selected portion of the image with a hash table comprising data corresponding to a set of colors;
determining a color within the set of colors corresponding to the selected portion of the image; and
presenting a representation of the color.

16. The computer-readable media of claim 15, wherein the selected portion of the image is a pixel, the user interface device is hovered over the pixel for a set period of time to obtain the value associated with the pixel.

17. The computer-readable media of claim 15, wherein the representation of the color is presented in the form of text or a symbol.

18. The computer-readable media of claim 15, wherein the hash table is constructed utilizing one or more color difference values and a color name list comprising a list of colors selected based on parameters comprising a color coverage, a diversity of colors, or a color usage frequency.

19. The computer-readable media of claim 15, wherein the user interface device comprises a mouse, a stylus, or a voice command.

20. The computer-readable media of claim 15, wherein the selected portion of the image is a region or an object within the image.
